(19) United States
(12) Patent Application Publication
(10) Pub. No.: US 2012/0101245 A1
(43) Pub. Date: Apr. 26, 2012

(54) THERMOCOUPLE HEATING

(75) Inventors: Philip David Coates, Leeds (GB); Ken Howell, West Yorkshire (GB); Mike Martyn, West Yorkshire (GB)

(73) Assignee: UNIVERSITY OF BRADFORD, Bradford, West Yorkshire (GB)

(21) Appl. No.: 12/673,023

(22) PCT Filed: Aug. 1, 2008
(86) PCT No.: PCT/GB08/02654

§ 371 Date: Jul. 21, 2010

(30) Foreign Application Priority Data
Aug. 11, 2007 (GB) 0715709.2

(51) Int. Cl. C08F 110/06; H05B 1/00

(52) U.S. Cl. 526/351; 219/209; 432/1

(57) ABSTRACT

There is described a method of affecting a thermally induced change to a material which comprises the use of a thermocouple or of a resistance temperature detector as a supply of thermal energy.

This invention relates to a novel method of affecting a thermal change to a material, in particular to shape memory materials, to novel uses therefore and to methods of treatment related thereto.

A shape memory material is one that undergoes a change of structure at a certain temperature, usually called the transformation temperature. Above this temperature the material has a given structure, e.g. crystalline, amorphous, etc., and below this temperature it has another. The high temperature structure of these types of materials allows the material to be easily and apparently permanently deformed at a temperature below the melt temperature. However, on re-heating, the orientation of the material is released and thus, the material has “remembered” its shape.

Oriented, e.g. die drawn, thermoplastic polymers are well known as shape memory materials. For example, International Patent application No. 80/02671 to Ward, Coates and Gibson, discloses a process for the solid phase deformation of an orientable thermoplastic polymer. The process includes heating the polymer shape to below the melting point of the polymer and then extruding the polymer through a die that is heated to a temperature at least as high as the temperature of the polymer.

Furthermore, it is well known that a shape memory material will revert or relax to its original structure when heated above its transformation temperature. Thus, an oriented polymer, e.g. a die drawn polymer, will revert to its disorientated pre-drawn proportions if the oriented polymer is heated above its transformation temperature.

More recently this principle has been used in the surgical/medical field as offering a means of locking together two or more pieces of bone or synthetic bone. Thus, for example, a hole is provided in each portion of bone or synthetic bone and an anchor or dowel, e.g. a rectangular dowel, comprising a shape memory material, such as an oriented polymer, is inserted in the corresponding holes. Upon heating the anchor or dowel to the required transition temperature, typically 80° C., the oriented polymer disorients and the cross-sectional ratio transposes through 90°. Consequently the dowel locks within the holes of the “bone” sections, fixing them together. It will be appreciated that in such an application it is especially desirable to apply localised heating so that, inter alia, discomfort to the patient or local cell damage is avoided or minimised.

Conventionally, in the surgical/medical field the necessary heat is applied to the oriented polymer by the use of, for example, a hot water bath. However, this approach suffers from the disadvantage that, inter cilia, there is a lack of precise temperature control and it is difficult to provide the heat in situ and/or in a confined space presented by, for example, the surgical environment. Moreover, as already described herein, the existing method, e.g. use of a hot water bath, does not address the desirability of localised heating and also does not facilitate in situ heating.

Thermocouples are a widely used as a type of temperature sensor and can also be used as means to convert thermal potential difference into electric potential difference. Thermocouples are advantageous in that they are inexpensive and readily changeable. In addition, due to their small size they are well suited for measurement of localised temperatures. Furthermore, they are conventionally used to measure a wide range of temperatures.

Recently, Jung, D. H., et al in The 27^{th} Japan Symposium on Thermophysical Properties, 2006, Kyoto, 255-258, describe the use of a single thermocouple as a simultaneous heater and temperature sensor, as part of a gas pressure sensor.

However, we have now surprisingly found that a thermocouple may be used as a source of thermal energy for other materials, e.g. solid or liquid phase materials, and may therefore be utilised, inter alia, to overcome or mitigate the disadvantages currently experienced with affecting a thermal material change in general and, in particular, reversion of shape memory materials hereinbefore described, such as, oriented polymers.

This finding provides a novel opportunity to affect a tangible change to solid state materials, including but not limited to, polymers.

Thus, according to first aspect of the invention we provide a method of affecting a thermally induced change to a material which comprises the use of a thermocouple as a supply of thermal energy.

In particular, we have found that when a pulsed current is applied through a thermocouple junction, the resistance encountered causes localised heating. Furthermore, the short inter-pulse period enables the thermocouple to return a very small temperature-related voltage, and this permits the system to act as a temperature sensor and/or gauge the distance from the target temperature. Thus, the pulse repetition frequency (PRF) or the duty cycle (the ratio of the duration of the pulse, in a given period, to the period) may be adjusted accordingly.

Therefore, in addition to the thermocouple acting as a source of thermal energy, it may advantageously be employed in a more conventional manner as a temperature sensor, e.g. a controlling temperature sensor. Therefore, it is an especially preferred aspect of the present invention that the thermocouple will have the dual function of acting as a heat source and a temperature sensor. Preferentially, in use a pulsed electric current is applied across the thermocouple so that the functionality of the thermocouple will itself alternate between a thermal energy supply and a temperature sensor.

Therefore, according to a further aspect of the invention we also provide the use of a thermocouple as a heat source for a solid or liquid state material and especially the use as a combined heat source and temperature sensor. In a preferred aspect of the invention the use of the thermocouple as hereinbefore described is as a heat source for a solid state material.

The choice of thermocouple may vary depending upon, inter alia, the desired material and consequently the desired temperature to be achieved. However, suitable thermocouples, which may be mentioned include Ni—Cr/Ni—Al; Ni—Cr/Cu—Ni; Fe/Cu—Ni; Ni—Cr—Si/Ni—Si; Cu/Cu—Ni; (W with 5% Re/W 26% Re and Ni/Ni—Mo. A common range of exemplary thermocouples, together with the types of metals employed, is included in Table I herein for illustrative purpose only.

It will be understood by the person skilled in the art that the thermocouple may be replaced by a Resistance Temperature Detector (RTD). An RTD exploits the fact that many metals exhibit a relatively linear change in resistance for any given change in temperature. Thus, by measuring the resistance of the RTD, an inference may be made of its temperature. One of the advantages of the RTD over the thermocouple is that its resistance is two or three orders of magnitude greater than the thermocouple, so that whereas a thermocouple may have a resistance of perhaps one Ohm, a RTD could be several hundred Ohms. Thus, almost all of the current passing through the circuit will dissipate its energy locally within the RTD and not in the lead wires, which is the case with thermocouple. A further advantage is that the heating need not be switched off in order to make a measurement; instead, by simultaneously monitoring supply current and voltage, the resistance (and thus temperature) may be monitored continuously in real-time.

Thus, according to a yet further aspect of the invention we provide a method of affecting a thermally induced change to a material which comprises the use of a Resistance Temperature Detector in conjunction with a heating element.

In the method or use of the invention a variety of materials may be used. It will be appreciated that the method is particularly applicable to solid state materials. However, the application of thermal energy is particularly important in the field of polymers in general and therefore, in a preferred aspect of the invention the material may be a polymer. Importantly, the application of thermal energy to polymers such as oriented or aligned polymers has the significance of causing the oriented polymer to disorientate and substantially revert to its pre-oriented state. Therefore, the method of the invention is especially useful in disorienting an oriented polymer. When the material is an oriented polymer, the oriented polymer may comprise as a whole or in part, uniaxial, biaxial or triaxial orientation. It is a particularly preferred aspect of the invention that the thermal change may comprise the reversion or disorientation of the oriented polymer.

As hereinbefore described, oriented polymers are known in the art, wherein the polymer may be an uniaxial, biaxial or triaxial alignment. Polymers comprise discrete polymer chains which may be aligned or oriented to render the polymer in uniaxial, biaxial or triaxial alignment. Alignment or orientation is suitably conferred by processing. The oriented polymer is therefore distinct from the polymer, which has not been processed to confer orientation, and in which the polymer chains are typically in random alignment. Similarly, the disoriented polymer is also distinct from the oriented polymer. Orientation and/or the degree of orientation may be determined by techniques known in the art, such as scanning electron microscopy (SEM), differential scanning calorimetry (DSC), X-ray, optical microscopy and transmission electron microscopy (TEM). The person skilled in the art will understand that other analytical techniques may also be suitable.

A variety of polymers and/or copolymers may be used and may depend upon the application of the thermally altered material. It is therefore a particular aspect of the present invention to provide a method of disorienting an oriented polymer by the application of thermal energy with a thermocouple. The degree of disorientation may vary such that the disoriented polymer may comprise a single phase disoriented polymer or a multi phase, e.g. biphase polymer.

Generally, the use of a thermocouple as hereinbefore described may be applied to any known thermoplastic material. Polymers which may be mentioned include, but are not limited to, acrylonitrile butadiene styrene (ABS), acrylic, celluloid, cellulose acetate, ethylene-vinyl acetate (EVA), ethylene vinyl alcohol (EVAL), fluoroplastics (PTFEs, including FEP, PFA, CTFE, ECTFE, ETFE), liquid crystal polymer (LCP), polyacetal (POM or acetal), polyacrylates (acrylic), poly(n-butyl methacrylate) (PBMA), Poly(methyl methacrylate) (PMMA), polyacrylonitrile (PAN or ascrylonitrile), polyamide (PA or nylon), polyamide-imide (PAT), polyaryletherketone (PAEK), polybutadiene (PBD), polybutylene (PB), polybutylene terephthalate (PBT), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), polyethylenechlorinates (PEC), polyimide (PI), polylactic acid (PLA), poly-L-lactide (PLLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC) and polyvinylidene chloride (PVDC); and copolymers and mixtures thereof.

However, thermally altered polymers and thermally disoriented polymers are especially useful in the surgical and/or medical field. Therefore, in this field, examples of such polymers include, but shall not be limited to, high strength, biocompatible, organic polymers, including polyolefins, such as, polypropylene, polyethylene, e.g. ultra-high molecular weight polyethylene (UHMWPE); polyesters, polyamides, bioabsorbable or biodegradable polymers, such as polylactic acid, polyglycolic acid, polypeptides, polyhydroxybutyrates, polycaprolactones, polydioxanones, and optionally copolymers and/or blends thereof.

In addition, it is within the scope of the present invention to incorporate one or more plasticisers in the polymer and/or one or more fillers, for example, osteoconductive materials and/or biologically active materials, such as, hydroxyapatite or calcium salts, e.g. calcium sulphate, calcium carbonate, etc. The amount of filler which may be included may vary and may depend, inter alia, upon the nature of the filler.

In use, the thermocouple may be in direct contact with the shape memory material. However, it is within the scope of the present invention to include the use of a heat transfer medium, such as a heat transfer paste, such as a metal oxide, e.g. zinc oxide.

Such polymers may undergo a variety of changes when subject to thermal energy. However, in a preferred aspect of the invention the polymer that is the “starting material” is an oriented polymer. The polymer and/or the oriented polymer which forms the precursor(s) to the disoriented polymers may be prepared by conventional processes known per se. Thus, for example, the oriented polymer may be prepared by aligning the melt phase polymer followed by cooling. The alignment may comprise drawing, e.g. die drawing, spinning or moulding the melt phase polymer to orient the polymer chains in the direction of draw, spin or direction of moulding. In the present invention a preferred oriented polymer is a die drawn polymer.

For a given oriented polymer the degree of reversion or relaxation may vary depending upon the deformation ratio of the oriented polymer. The “deformation ratio” is the ratio of the initial cross-sectional area of the polymer material to the final cross-sectional area of the, e.g. drawn, polymer. Thus, for example, an oriented polymer with an initial very low deformation ratio will not show a substantial material change when heated to the transformation temperature to permit reversion and disorientation. Conversely, and by way of example only, an oriented polymer with a very high deformation ratio will show a significant, and possibly excessive, reversion when heated to the transformation temperature. Therefore, in a preferred embodiment of the invention the oriented polymer which is a precursor(s) to the disoriented polymer, may have a deformation ratio of 1:30, preferably 1:10 and especially 1:4, 1:3 or 1:2, e.g. a deformation ratio of from 1:30 to 1:4, preferably from 1:20 to 1:4 and especially form 1:10 to 1:4. Alternatively, the oriented polymer may be a substantially amorphous polymer, in which case it may have a low deformation ratio of, 1:2 or less, for example, from 1:1.1 to 1:1.5, preferably from 1:1.2 to 1:1.4. In a yet further alternative embodiment the oriented polymer may comprise a “gradient material”. By the term a “gradient material” we mean a material, e.g. an oriented polymer in which the deformation ratio is variable. Indeed, it is a particular aspect of the present invention that draw ratio gradient materials may advantageously be prepared. Thus, according to a yet further aspect of the invention we provide a draw ratio gradient material as hereinbefore described. We furthermore provide a process for manufacturing as such a draw ratio gradient material. When the polymer comprises a gradient material, the draw ratio gradient may vary and may be, for example, from isotropic, e.g. draw ratio equals 1 to any of the aforementioned draw ratios.

Therefore, for example, the application of thermal energy results in the disorientation and reversion of the die drawn polymer. However, it will be understood by one skilled in the art that the heat treatment of polymers using a thermocouple may have other applications in addition to the preferred application of disorientation and therefore the use of a thermocouple in the manner described herein should not be construed as limited to its use in disorientation of polymers. Moreover, a particular advantage of the use of a thermocouple according to the present invention is that a thermocouple facilitates the control of voltage, temperature and/or time, each of which may be advantageous in manipulating a shape memory material, such as an oriented polymer. Thus, for example, the control offered by a thermocouple as hereinbefore described, enables the transformation temperature to be controlled such that, if desirable, a shape memory material may undergo only partial reversion or relaxation.

The heat treated polymers and especially the disoriented polymers may find utility in a variety of applications, including the surgical/medical field.

Further fields which may be mentioned are;

### Micro-Moulding and Nano-Technology

Present design causes much of the power to be lost along the length of the circuit. However, much more efficient means of heating could be achieved through the use of carefully managed evaporation techniques. Thermocouple metals may be evaporated onto a target area, e.g. on the inside of a micro-mould, for example, on the inside of a window. The evaporation of the metals may be applied in a longitudinal thickness-gradient—and consequent resistance/heating gradient.

Micro-actuators can be constructed, exploiting the thermocouple dissimilar-metals as an ultra-miniature bi-metal strip. Thus, the pulsed heating/sensing principle permits accurate small-scale positioning, such as Quantum-tunnelling (QT) devices—tiny 3 mm-square pads, the resistance of which varies according to their degree of compression. The tiniest compression can result in a resistance transition from 10̂12 ohms, through to 10̂1 ohms. An enhancement to the actuators can be achieved by the use of these devices as resistance-dependant positional feedback sensors.

Single-wire Heaters are possible; wherein one wire of a suitable thermocouple metal could be bonded to a relatively large mass of a micro-mould, and by invoking “the principle of intermediate metals”, the thermocouple partner-metal can be attached at some relatively remote spot elsewhere on the system chassis. Though the two sites may be at differing temperatures, knowledge of the temperature at the exit-site enables computation of the temperature at the entry-site.

2-Dimensional heating profiles can be achieved through a multiple single-wire system across a target area. Thus, a pseudo-tomographic cross-sectional temperature-map can be created, where the nodes are not only sensor-points, but are also heaters combined.

However, the disoriented polymers of the invention are particularly useful in a surgical/medical environment. As hereinbefore described the disoriented polymers find particular utility in the surgical/medical field as implantable devices and especially fixation devices. Examples of such an implantable device include, but are not limited to, suture anchors, soft tissue anchors, bone anchors, screws, such as interference screws, nails, fracture fixation plates and rods tissue engineering scaffolds, maxillo-facial plates, fibres, e.g. fibre bundles and arrangements, meshes and other such devices used in tissue and/or bone repair or replacement.

Furthermore, it is a particular advantage of this aspect of the present invention is that, inter alia, an implantable device may be constructed of an oriented polymer and by the application of a thermocouple, the implantable device may be readily heat treated in situ to cause the reversion of the polymer material to a disoriented polymer.

Therefore, in a further aspect of the present invention we provide an implantable device comprising a disoriented polymer as hereinbefore described wherein the disoriented polymer is the result of the thermocouple heat treatment of an oriented polymer. In an additional aspect of the invention we provide an implantable device comprising an oriented polymer precursor for use in conjunction with a thermocouple for the “manufacture” of disoriented polymeric implantable device.

Where only temporary residence in a patient is desired, the implantable device according to this aspect of the invention may optionally comprise one or more biodegradable materials.

Furthermore we provide a method of surgical fixation, e.g. soft tissue or bone fixation, which comprises the use of a thermally disoriented polymer as hereinbefore described.

More particularly the method of surgical fixation as hereinbefore described comprises positioning a biocompatible material using an oriented polymer material and thermally disorienting the material in situ using a thermocouple to produce a fixation device. Preferentially, in the method of the invention the thermocouple is used as a source of thermal energy and a temperature sensor.

We further provide an implantable device as hereinbefore described wherein the device is manufactured according to the process of the invention. Such an implantable device may be a suture anchor, soft tissue anchor, bone anchor, screw, such as an interference screw, nail, fracture fixation plate, rod, tissue engineering scaffold, maxillo-facial plate, and other such device used in tissue and/or bone repair or replacement.

According to a further aspect of the invention we provide a process for the preparation of a disoriented polymer which comprises applying thermal energy to an oriented polymer wherein the thermal energy is supplied by a thermocouple. In the process of the invention the thermocouple may be used as a source of thermal energy and a temperature sensor.

It will be understood by one skilled in the art that the disoriented polymer produced according to this aspect of the invention may be wholly or substantially disoriented. The degree of disorientation may vary such that the disoriented polymer may comprise a single phase disoriented polymer or a multi phase, e.g. biphase polymer. The degree of disorientation may vary depending upon, inter alia, the nature of the polymer, the application, etc. Indeed, as hereinbefore described, the control offered by a thermocouple, enables only partial disorientation of the shape memory material if desirable. Thus, the control offered by a thermocouple permits a range of distortions to be achieved and thus a gradient material as hereinbefore described may be produced. However, it is preferred that the reverted shape memory material, e.g. the disoriented polymer is at least 50% disoriented, preferably at least 75% disoriented, more preferably at least 90% disoriented.

According to a further aspect of the invention the novel thermocouple heating device may be exploited as a well controlled, heated, mandrel in a die drawing process. Such utilisation is advantageous in the manufacture of, inter alia, cannulae.

The thermocouple is used as a controlled heater using the developed innovation. Heating takes place locally near the hot junction end of the thermocouple. The heated end of the mandrel may be at any position in relation to the exit surface of the die. The heated mandrel provides added control over the orientation, hence properties such as modulus and recovery, in the drawn product. Property gradients are achieved by creating a temperature gradient in the material being drawn. The temperature gradient leads to an orientation gradient across the tube diameter. The device has been used to produce drawn product that exhibits a profiled, i.e. non-uniform, recovery when heated above the Tg of the polymer, for example, due to less recovery at the bore. For example it is possible to have the mandrel temperature greater than the Tg of the material hence reducing the level of orientation developed locally in the material close to the wall of the hole in the drawn product.

In the process of the invention after the first current pulse (duration 100 mS), power may be removed, and the thermocouple may be switched to sensor mode in order to determine proximity to the desired target temperature. One or more further pulses may be applied, then another, and so on, such that the desired temperature is reached in the shortest time. Thereafter a slower series of “maintenance-pulses” may be applied until reversion or disorientation is complete. Optionally, the thermocouple may include or may be incorporated in a microcontroller-based system.

In a surgical/medical environment, as described herein, in order to reach the desired temperature with the speed needed in (in the order of about ten seconds), a relatively high current is needed (between two and three amps at twelve volts) to produce the necessary thermal output.

As previously mentioned herein, the voltage applied across the thermocouple may be pulsed, and the duration of each pulse—and consequent heating—may be modulated under the control of the thermocouple's feed-back voltage. The feedback becomes measurable only during the “off” part of the cycle. This form of modulation is referred to as Pulse Width Modulation (PWM).

Two other control options are available:

### (a) Variation in the Pulse Repetition Frequency (PRF);

(b) Variation in the pulse amplitude—Pulse Amplitude Modulation (PAM).

The PWM and the PRF share interdependency, and are better viewed as a PWM-PRF-pair. Tests are ongoing to establish the optimum balance between the two for any given situation.

The PAM however is independent, and merit has been found in the exploitation of this third variable. However, as this amplitude is intended to be continuously-variable, some thought had to be given to the amplitude's control mechanism in order to avoid over-heating the drive-transistors. This was achieved by driving the transistors at saturation levels (full-on/full-off) and at a significantly higher frequency than the primary PRF referred to above. Consequently, each of the “on” pulses within the primary pulse-train is itself a pulse-burst rather than a solid ON-OFF pulse, and hence the values assigned to this secondary PRF-PWM-pair will determine the mean amplitude of the primary pulse.

According to a further aspect of the invention we provide the use of a disoriented device as hereinbefore described as an implantable, optionally biodegradable, fixation device suitable for implantation into an animal, e.g. human, body. Examples of such an implantable device includes, but are not limited to, suture anchors, soft tissue anchors, bone anchors, screws, such as interference screws, nails, fracture fixation plates and rods, tissue engineering scaffolds, maxillo-facial plates, and other such devices used in tissue and/or bone repair or replacement.

In addition to the desirable surgical/medical applications which are made possible by the present invention, many other opportunities utilising oriented-polymer reversion, and thermocouple heater/sensor might be exploited further. Some of these opportunities are briefly described below.

The invention will now be described by way of example only and with reference to the accompanying drawings, in which

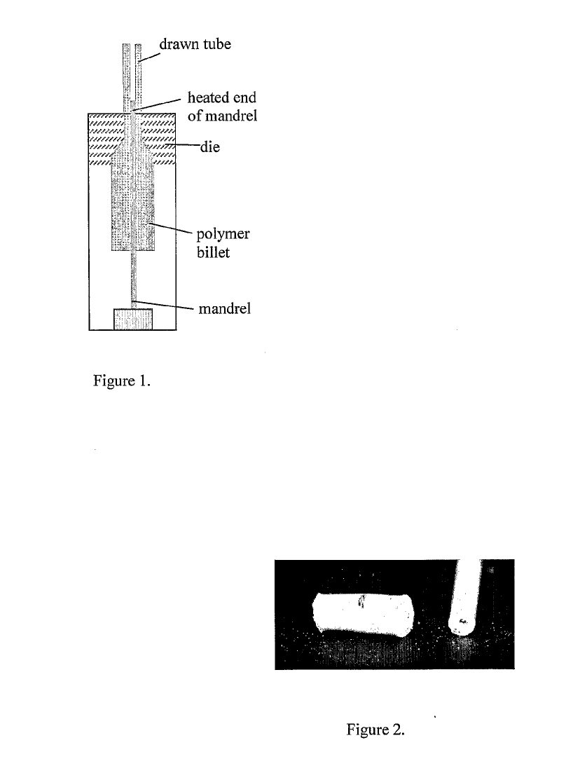

FIG. 1 is a schematic representation of the thermocouple being used as a mandrel;

FIG. 2 is an image of the drawn tube and the recovered product; and

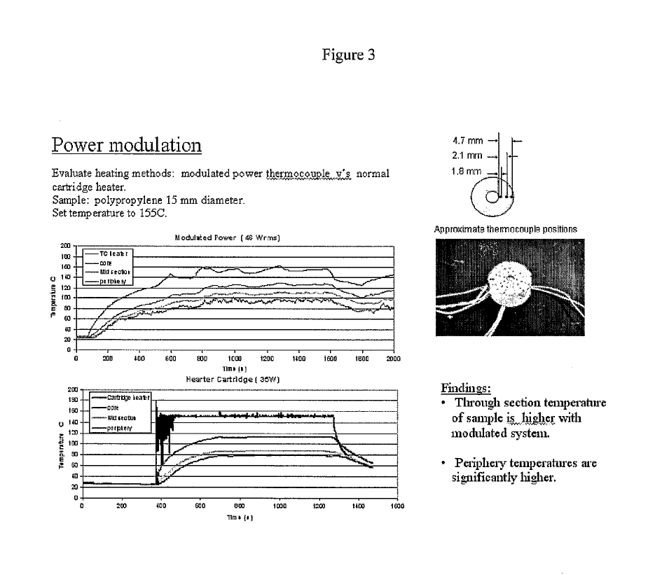

FIG. 3 represents graphically the effect of power modulation on a 15 mm diameter polypropylene sample versus the use of a heater cartridge.

### EXAMPLE 1

### Heated Mandrel

The thermocouple heating device was exploited as a well controlled, heated, mandrel in a die drawing process. The set up is as shown schematically in FIG. 1.

In a specific example a thermocouple heater of 1.4 mm diameter was used in the die drawing of a copolymer. The die temperature was set at 75° C. and the end of the thermocouple was controlled at approximately 100 C and located above the exit of the die. The drawn product exhibited a variable recovery, with the core material having little recovery and the surface reaching nearly 40% recovery. This created a product of variable diameter. An image in FIG. 2 shows an original drawn tube produced using this heated mandrel and along with the recovered product. The invention is particularly advantageous in creating drawn tubes with small bores, typically 3 mm or less, in drawn product.

### EXAMPLE 2

### Power Modulation

A pulsed power mode was used to control the temperature of the novel thermocouple (T/C) heater system. This permits the temperature to be measured between pulses, and the saturation nature of the pulses (full-on/full-off) ensures maximum efficiency with minimal heating and consequent power-loss in the control circuitry. Furthermore, using pulse width modulation (PWM) a much finer tuning of temperature may be achieved, with the potential for full ‘Proportional Integral Differential’ control, should the application demand.

Pulse Amplitude Modulation permits the heater to be significantly “over-driven” for a very short time, the series high-temperature pulses resulting in what might be described as radially propagating series of concentric heat bands. Though the underlying physics has not yet been fully determined, empirical evidence strongly indicates that a more evenly distributed heat gradient can be obtained compared to earlier methods of lower pulse amplitude and different pulse rates.

The pulsed amplitude modulation has been used to control the temperature of the thermocouple (T/C) heater system. We note that contemporary thermoresistive devices, such a heater cartridges with in-built thermocouple sensors, would also work with this system. The heating device was controlled in such a fashion as to provide high bursts of energy for short periods (ms) of time. The device is found advantageous in heating materials which have poor thermal properties (conductivity, heat capacities), such as thermoplastics. The energy supplied to the device with the Pulse Amplitude Modulation control can be delivered to material in contact with the device without excessive melting of material in immediate contact with the device. Power modulation allowed heat to dissipate from the point of contact through the bulk of the material without melting the material.

A particular advantage of this mode of heating leads is a reduced temperature gradient through the material. The data in Table I demonstrates this effect. The temperature gradient developed across a polypropylene sample using a standard controlled cartridge heater and Pulse Amplitude Modulation thermocouple heater is compared. The heaters are both 3.0 mm in diameter. It is clearly shown that the modulated power heater leads to higher temperatures through the section of polypropylene with the periphery of the sample being approximately 15° C. higher than can be achieved using a conventionally controlled cartridge heater of the same power rating. In the broader sense, the technique allows choice and control of the final thermal gradient in the heated material.

TABLE I

| | Positive | Negative | Accuracy*** | Range ° C. | |
|---|---|---|---|---|---|
| Type | Material | Material | Class 2 | (extension) | Comments |
| B | Pt, 30%Rh | Pt, 6%Rh | 0.5% >800° C. | 50 to 1820 | Good at high temperatures, no |
| | | | | (1 to 100) | reference junction compensation |
| | | | | | required. |
| C*** | W, 5%Re | W, 26%Re | 1% >425° C. | 0 to 2315 | Very high temperature use, brittle |
| | | | | (0 to 870) | |
| D** | W, 3%Re | W, 25%Re | 1% >425° C. | 0 to 2315 | Very high temperature use, brittle |
| | | | | (0 to 260) | |
| E | Ni, 10%Cr | Cu, 45%Ni | 0.5% or 1.7° C. | −270 to 1000 | General purpose, low and medium |
| | | | | (0 to 200) | temperatures |
| G** | W | W, 26%Re | 1% >425° C. | 0 to 2315 | Very high temperature use, brittle |
| | | | | (0 to 260) | |
| J | Fe | Cu, 45%Ni | 0.75% or 2.2° C. | −210 to 1200 | High temperature, reducing |
| | | | | (0 to 200) | environment |
| K* | Ni, 10%Cr | Ni, 2%Al | 0.75% or 2.2° C. | −270 to 1372 | General purpose high temperature, |
| | | 2%Mn | | (0 to 80) | oxidizing environment |
| | | 1%Si | | | |
| L** | Fe | Cu, 45%Ni | 0.4% or 1.5° C. | 0 to 900 | Similar to J type. Obsolete—not for |
| | | | | | new designs |
| M** | Ni | Ni, 18%Mo | 0.75% or 2.2° C. | −50 to 1410 | |
| N* | Ni, 14%Cr | Ni, | 0.75% or 2.2° C. | −270 to 1300 | Relatively new type as a superior |
| | 1.5%Si | 4.5%Si | | (0 to 200) | replacement for K Type. |
| | | 0.1%Mg | | | |
| P** | Platinel II | Platinel II | 1.0% | 0 to 1395 | A more stable but expensive substitute |
| | | | | | for K & N types |
| R | Pt, 13%Rh | Pt | 0.25% or 1.5° C. | −50 to 1768 | Precision, high temperature |
| | | | | (0 to 50) | |
| S | Pt, 10%Rh | Pt | 0.25% or 1.5° C. | −50 to 1768 | Precision, high temperature |
| | | | | (0 to 50) | |
| T* | Cu | Cu, 45%Ni | 0.75% or 1.0° C. | −270 to 400 | Good general purpose, low |
| | | | | (−60 to 100) | temperature, tolerant to moisture. |
| U** | Cu | Cu, 45%Ni | 0.4% or 1.5° C. | 0 to 600 | Similar to T type. Obsolete—not for |
| | | | | | new designs |

*Most commonly used thermocouple types,
**Not ANSI recognized types.
***See IEC 584-2 for more details. Materials codes:- Al = Aluminium, Cr = Chromium, Cu = Copper, Mg = Magnesium, Mo = Molybdenum, Ni = Nickel, Pt = Platinum, Re = Rhenium, Rh = Rhodium, Si = Silicon, W = Tungsten

1-55. (canceled)

56. A method of effecting a thermally induced change to a material comprising the step of supplying thermal energy to the material using a thermocouple or a Resistance Temperature Detector.

57. A method according to claim 1 wherein the material is a solid state material.

58. A method according to claim 1 wherein the thermocouple has the dual function of acting as a supply of thermal energy and a temperature sensor.

59. A method according to claim 1 wherein, in use, a pulsed electric current is applied across the thermocouple.

60. A method according to claim 1 wherein the thermocouple is selected from one or more of Ni—Cr/Ni—Al; Ni—Cr/Cu—Ni; Fe/Cu—Ni; Ni—Cr—Si/Ni—Si; Cu/Cu—Ni; (W with 5% Re/W 26% Re and Ni/Ni—Mo.

61. A method according to claim 1 wherein the method comprises the disorientation of an oriented polymer.

62. A method according to claim 1 wherein the tensile strength of the disoriented polymer is in the range of from 100 MPa to 1000 MPa.

63. A method according to claim 6 wherein the polymer comprises a surgical or medical implantable device.

64. An implantable device comprising a disoriented polymer wherein the disoriented polymer is the result of the thermocouple heat treatment of an oriented polymer.

65. A method of surgical fixation comprising the step of thermally disorienting an oriented biocompatible material using a thermocouple to produce a fixation device.

66. A method for the preparation of a disoriented polymer comprising the step of applying thermal energy to an oriented polymer wherein the thermal energy is supplied by a thermocouple.
